(19) United States
(12) Patent Application Publication
(10) Pub. No.: US 2008/0073815 A1
(43) Pub. Date: Mar. 27, 2008

(54) Vulcanizable composition based on ethylene-vinyl acetate copolymers, preparation thereof and use for production of products with elastomeric properties

(76) Inventors: Stefan Kelbch, Much (DE); Kay Varnhorn, Leverkusen (DE); Olaf Isenberg-Schulz, Langenfeld (DE); Ulrich Frenzel, Neuss (DE); Jurgen Ismeier, Forstinning (DE)

Correspondence Address: LANXESS CORPORATION, 111 RIDC PARK WEST DRIVE, PITTSBURGH, PA, 15275-1112, US

(21) Appl. No.: 11/895,963

(22) Filed: Aug. 28, 2007

(30) Foreign Application Priority Data
Sep. 2, 2006 (DE) 10 2006 041 464.0

(51) Int. Cl. C08F 18/08; B29C 45/00

(52) U.S. Cl. 264/328.1; 525/342; 525/370

(57) ABSTRACT

A vulcanizable composition based on ethylene-vinyl acetate copolymers is prepared with vinyl acetate content of at least 45% by weight, based on the copolymer, and these can be crosslinked in the absence of peroxides. These mixtures comprise at least one organotin catalyst and a specific crosslinking agent. A process is moreover described for preparation of these vulcanizable compositions, and their use is described for production of products with elastomeric properties.

### FIELD OF THE INVENTION

The invention relates to a vulcanizable composition comprising an ethylene-vinyl acetate copolymer, an organotin catalyst and a specific crosslinking agent, a process for preparation of this vulcanizable composition, and also its use for production of products with elastomeric properties.

### BACKGROUND OF THE INVENTION

The crosslinking of ethylene-vinyl acetate copolymers (also termed EVA) using a transesterification reaction has hitherto been described mainly for thermoplastic ethylene-vinyl acetate copolymers, i.e. copolymers whose vinyl acetate content is comparatively smaller. The main focus here is on the ethylene-vinyl acetate copolymer products available commercially, these comprising by way of example from 26 to 28% by weight of vinyl acetate, or from 38 to 41% by weight or from 39 to 42% by weight of vinyl acetate.

Polymer Engineering and Science 32 (15), (1992), 998-1013 discloses a transesterification reaction in the presence of DBTO (dibutyltin oxide) as catalyst, but in the absence of crosslinking agents, with the aim of crosslinking an ethylene-vinyl acetate copolymer whose vinyl acetate-content is about 24% by weight with poly(ethylene acrylate-co-propylene). The network bridges of the resultant vulcanisates are composed only of —O—C(═O)— groups.

Polymer 1993, 34 (1), 124-131 describes the crosslinking of ethylene-vinyl acetate copolymers with ethylene-methyl acrylate copolymers in the presence of dibutyltin oxide as catalyst, but in the absence of crosslinking agents. EVA copolymers used are those whose vinyl acetate content is 28% by weight. The network bridges of the resultant crosslinked copolymers are therefore likewise composed only of —O—C(═O)— groups.

Macromol. Chem. 194 (1993) 665-675 describes transesterification of EVA with vinyl acetate content of 14% by weight with 1-octanol using DBTO and DBTDL (dibutyltin dilaurate). Other catalysts likewise used, for example dibutyltin sulphide (DBTS), Zn(OAc)₂ (zinc acetate dihydrate) or tetrabutoxytitanium (Ti(OBu)₄), did not lead to transesterification.

J. of Applied Polymer Science 65 (1997) 2457-2469 describes graft copolymers based on ethylene-vinyl acetate copolymers (EVA) with 9 or 28% by weight content of vinyl acetate, and also polybutylene terephthalate (PBT), a transesterification reaction being carried out using dibutyltin oxide, but in the absence of crosslinking agents, with the aim of using the resulting graft copolymer for increasing the compatibility in blends of the polymers EVA and PBT, which are intrinsically incompatible.

J. of Applied Polymer Science 79 (2001), 1556-1562 studies the transesterification crosslinking of ethylene-vinyl acetate copolymers whose vinyl acetate content is 28% by weight using dimethyl terephthalate (DMT) in the presence of the various catalysts dibutyltin oxide, titanium tetrabutoxide, zirconium tetraethoxide and p-toluenesulphonic acid. Whereas the use of DBTO leads to crosslinking, no crosslinking of any kind of the EVA copolymer can be observed in the presence of titanium tetrabutoxide, zirconium tetraethoxide and p-toluenesulphonic acid with DMT.

Polymer 43 (2002), 6085-6092 also describes crosslinking of an ethylene-vinyl acetate copolymer whose vinyl acetate content is 28% by weight in the presence of dibutyltin oxide as catalyst and of an alkoxysilane, such as tetramethoxy-, tetraethoxy- or tetrapropoxysilane by way of transesterification.

Polym. Int. 53 (2004), 523-535 describes the preparation of a novel thermoplastic vulcanisate (TPV) based on polypropylene as thermoplastic phase and on an ethylene-vinyl acetate copolymer as elastomer phase, by dynamic vulcanization of the elastomer phase using tetrapropoxysilane (TPOS) as crosslinking agent in the presence of dibutyltin oxide (DBTO). The ethylene-vinyl acetate copolymer has vinyl acetate content of from 26 to 42% by weight.

EP-B-0 461 247 describes a process for the crosslinking of (co)polymers which contain chlorine, ester, NH or carbonate groups, by reacting these at from 100 to 300° C. in absence of solvent, metal soap and plasticizer with specifically defined organometal alcoholates based on tin, lead, bismuth or antimony. These copolymers can also be ethylene-vinyl acetate copolymers.

Ethylene-vinyl acetate copolymers with relatively high vinyl acetate content are in particular important for production of elastomeric products. The quality and application sectors of these elastomeric products are affected inter alia considerably by their low-temperature properties. The crosslinking agents used for crosslinking of these ethylene-vinyl acetate copolymers with relatively high vinyl acetate content have hitherto in fact comprised exclusively peroxides. The result of this is that ethylene-vinyl acetate copolymers thus crosslinked have short network bridges, their dynamic properties, and also their low-temperature flexibility, being sometimes somewhat unsatisfactory. Plasticizers and/or oils are usually added for adjustment of the low-temperature properties of elastomers generally. However, in the case of peroxide-crosslinked ethylene-vinyl acetate copolymers, this use has considerable attendant problems: fundamentally, all such plasticizers and/or oils reduce the efficiency of the peroxides, since a not insignificant number of the free radicals produced are generated in the oil/in the plasticizer and are consequently unavailable for the actual desired crosslinking of the ethylene-vinyl acetate copolymer chains (see W. Hoffmann Rubber Technology Handbook, Carl Hanser Verlag, 2nd (English-language) edition 1989, Chapter “4.2.4.1 Peroxides”, and also chapter “4.5.2 Plasticizers and Process Aids”). These oils/plasticizers can also interact in other ways through the peroxide. Aromatic oils have the greatest adverse effect on the quality of crosslinking, but undesirable effects are also observed for naphthenic oils and also for paraffin oils. Similar considerations apply to the plasticizers. Whereas by way of example coumarone/indene resins are suitable plasticizers for elastomer mixtures subjected to sulphur crosslinking, they are unsuitable for use with peroxide crosslinking. All plasticizers which have vinyl double bonds are detrimental to peroxide crosslinking.

Peroxidically crosslinked ethylene-vinyl acetate copolymer rubber mixtures moreover have further shortcomings, an example being relatively low tear propagation resistance at high temperatures (hot tear).

### SUMMARY OF THE INVENTION

Starting from the prior art, the object of the present invention consisted in providing a novel, vulcanizable composition which is based on elastomeric ethylene-vinyl acetate copolymers with the widest possible range of crosslinking agents, and also catalysts, which also permits use of plasticizers which function as peroxide scavengers or which in other ways reduce the efficiency of peroxide crosslinking. The intention was also to remove the remaining abovementioned shortcomings of peroxidically crosslinked ethylene-vinyl acetate copolymer rubber mixtures, e.g. relatively below tear propagation resistance at high temperatures (hot tear).

This object is achieved via the inventive vulcanizable compositions which do not require the presence of peroxides as crosslinking agents but instead function with use of silanes or titanates as crosslinking agents.

### DETAILED DESCRIPTION OF THE INVENTION

The invention therefore provides a vulcanizable composition comprising
a) at least one copolymer based on the monomers ethylene and vinyl acetate with vinyl acetate content of at least 45% by weight, based on the copolymer,
b) at least one organotin catalyst and
c) at least one crosslinking agent selected from the group consisting of silanes and titanates.

This novel vulcanizable composition, which comprises an organotin catalyst and a specific crosslinking agent, makes it possible on the basis of a transesterification reaction optionally either to carry out crosslinking, or else first to carry out functionalization and subsequently to carry out crosslinking, of ethylene-vinyl acetate copolymers whose vinyl acetate content is at least 45% by weight, without use of peroxides.

For the purposes of this application and invention, any of the definitions mentioned, either in general or mentioned in a very variety of preferred ranges, of radicals, parameters, or explanations, can be combined in any desired manner with one another, this therefore also applying to combinations between the respective ranges and preferred ranges.

Ethylene-Vinyl Acetate Copolymers

The ethylene-vinyl acetate copolymers (alternative terms used for the purpose of this application being ethylene-vinyl acetate copolymers, EVA or EVM) used in the inventive vulcanizable compositions comprise those whose content of vinyl acetate is at least 45% by weight, preferably in the range from 45 to 93% by weight, particularly preferably in the range from 45 to 90% by weight, very particularly preferably in the range from 45 to 85% by weight and in particular in the range from 50 to 80% by weight, based on the copolymer.

These ethylene-vinyl acetate copolymers are rubbers which can be prepared by methods familiar to the person skilled in the art or else are available commercially, e.g. in the form of the products whose trademarks are Levapren®, Levamelt® or Baymod® L from Lanxess Deutschland GmbH.

Organotin Catalysts

Examples of suitable organotin catalysts are the following classes
A Monoalkyltin compounds
B Dialkyltin compounds
C Trialkyltin compounds
D Triaryltin compounds
E Tetraalkyltin compounds
F Stannous salts of carboxylic acids not included in one of the abovementioned groups
   A Monoalkyltin Compounds

In the Monoalkyltin compounds of class A, alkyl is a straight-chain or branched C₁-C₂₀-alkyl radical, preferably C₁-C₈-alkyl radical, the compounds in particular being monobutyltin compounds or monooctyltin compounds.

Specifically, examples of monoalkyltin compounds used of class A are:
1. Monoalkyltin oxides, in which alkyl is a straight-chain or branched C₁-C₂₀-alkyl radical, preferably a straight-chain or branched C₁-C₈-alkyl radical.
   Preference is given to monobutyltin oxide (MBTO; (C₄H₉)SnOOH), and also monooctyltin oxide ((C₈H₁₇)SnOOH).
2. Monoalkyltin tricarboxylates of the formula
   (Alkyl)Sn(OOC-alkyl)₃
   in which the alkyl radicals are identical or different and are a straight-chain or branched C₁-C₂₀-alkyl radical, preferably a straight-chain or branched C₁-C₈-alkyl radical.
   Preference is given to butyltin tris(2-ethylhexanoate).
3. Monoalkyl dihydroxy chlorides of the formula
   (Alkyl)Sn(OH)₂Hal
   in which alkyl is a straight-chain or branched C₁-C₂₀-alkyl radical, preferably a straight-chain or branched C₁-C₈-alkyl radical and Hal is halogen.
   Preference is given to monobutyltin dihydroxy chloride ((C₄H₉)Sn(OH)₂Cl).
      B Dialkyltin Compounds

In the dialkyltin compounds of class B, alkyl is a straight-chain or branched C₁-C₂₀-alkyl radical, preferably a straight-chain or branched C₁-C₈-alkyl radical, the compounds in particular being dibutyltin compounds or dioctyltin compounds.

Specifically, examples of dialkyltin compounds used of class B are:
1. Dialkyltin oxides, in which alkyl is a straight-chain or branched C₁-C₂₀-alkyl radical, preferably a straight-chain or branched C₁-C₈-alkyl radical.
   Preference is given to dibutyltin oxide (DBTO; (C₄H₉)₂SnO) and dioctyltin oxide (DOTO; (C₈H₁₇)₂ SnO).
2. Dialkyltin sulphides, in which alkyl is a straight-chain or branched C₁-C₂₀-alkyl radical, preferably a straight-chain or branched C₁-C₈-alkyl radical.
   Preference is given to dibutyltin sulphide ((C₄H₉)SnS).
3. Dialkyltin dicarboxylates of the formula
   (Alkyl)₂Sn(OOC-alkyl)₂
   in which the alkyl radicals are identical or different and are a straight-chain or branched C₁-C₂₀-alkyl radical, preferably a straight-chain or branched C₁-C₈-alkyl radical.
   Preference is given to dibutyltin diacetate ((C₄H₉)₂Sn(OOCCH₃)₂), dibutyltin dilaurate (DBTL; (C₄H₉)₂Sn(OOCC₁₁H₂₃)₂), dioctyltin diacetate ((C₈H₁₇)₂Sn(OOCCH₃)₂), dioctyltin di(2-ethylhexanoate) ((C₈H₁₇)₂Sn(OOCC₇H₁₅)₂), dioctyltin dilaurate (DOTL (C₈H₁₇)₂Sn(OOCC₁₁H₂₃)₂) and dibutyltin dineodecanoate (C₄H₉)₂Sn(OOCC₉H₁₉)₂.
4. Dialkyltin dicarboxylates of the formula
   (Alkyl)₂Sn(OOC—R—COO)

in which the alkyl radicals are identical or different and are a straight-chain or branched C₁-C₂₀-alkyl radical, preferably a straight-chain or branched C₁-C₈-alkyl radical, and R is an alkylene radical, preferably a C₁-C₂₄-alkylene radical, which can also, if appropriate, have one or more double bonds.
Preference is given to dibutyltin maleate ((C₄H₉)₂Sn(OOCCH═CHCOO), dibutyltin bis(octyl maleate) and dibutyltin bis(octyl maleate) ((C₄H₉)₂Sn(C₂₄H₃₈O₈)₂.
5. Dialkyltin dihalides of the formula
   (Alkyl)₂Sn(Hal)₂
   in which the alkyl radicals are identical or different and are a straight-chain or branched C₁-C₂₀-alkyl radical, preferably a straight-chain or branched C₁-C₈-alkyl radical, and hal is halogen, preferably chlorine or bromine. Preference is given to dibutyltin dichloride.
      C Trialkyltin Compounds

In the trialkyltin compounds of class C, alkyl is a straight-chain or branched C₁-C₂₀-alkyl radical, preferably a straight-chain or branched C₁-C₈-alkyl radical, the compounds in particular being tributyltin compounds or trioctyltin compounds.

D Triaryltin Compounds

In the triaryltin compounds of class D, aryl is an aromatic C₅-C₂₄ radical in which, if appropriate, one or more of the ring carbon atoms can have been replaced by heteroatoms, preferably nitrogen, oxygen or sulphur.

Preference is given to triphenyltin compounds.

E Tetraalkyltin Compounds

In the tetraalkyltin compounds of class E, alkyl is a straight-chain or branched C₁-C₂₀-alkyl radical, preferably a straight-chain or branched C₁-C₈-alkyl radical, the compounds in particular being tetrabutyltin compounds or tetraoctyltin compounds.

Preference is given to tetrabutyltin, and also to tetraoctyltin.

F Stannous Salts of Carboxylic Acids not Included in One of the Abovementioned Groups

The stannous salts used of carboxylic acids preferably comprise stannous salts of C₂-C₂₀ carboxylic acids, preferably C₂-C₁₄ carboxylic acids, those preferably used being stannous acetate, stannous octoate and stannous ethylhexanoate.

Crosslinking Agents:

The crosslinking agent component c) in the inventive vulcanizable composition is selected from the group consisting of silanes and titanates.

Silanes:

By way of example, silanes of the general formula (I) are used 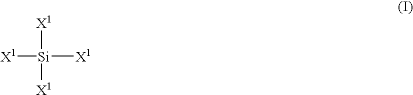
in which
X¹ are identical or different and are a group of the formula O—(R¹—O)ₘ—R², in which m is a whole number from 0 to 20, R¹ is a C₁-C₂₀-alkylene radical, preferably a C₁-C₈-alkylene radical, and R² is a straight-chain or branched C₁-C₂₀-alkyl radical, preferably a straight-chain or branched C₁-C₈-alkyl radical.

It is preferable to use silanes of the general formula (I) in which m is equal to 0 and R² are identical or different and are a straight-chain or branched C₁-C₈-alkyl radical, particularly preferably C₁-C₅-alkyl radical.

It is moreover preferable to use silanes of the general formula (I) in which m is equal to 1, R¹ are identical or different and are a C₁-C₈-alkylene radical, particularly preferably a C₁-C₅-alkylene radical, and R² are identical or different and are a straight-chain or branched C₁-C₈-alkyl radical, particularly preferably C₁-C₅-alkyl radical.

The silanes of the general formula (I) used are in particular tetramethoxysilane, tetraethoxysilane, tetra-n-propoxysilane, tetra-n-butoxysilane and tetrakis(2-butoxyethoxy)silane.

Silanes of the general formula (II) are moreover used, 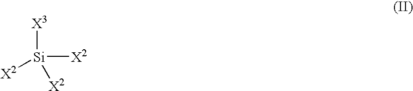
in which
X² are identical or different and
   are a straight-chain or branched C₁-C₂₀-alkyl radical, preferably C₁-C₈-alkyl radical, particularly preferably C₁-C₅-alkyl radical,
   a C₆-C₁₄-aryl radical, or
   a group of the formula O—(R¹—O)ₘ—R², in which
   m is a whole number from 0 to 20,
   R¹ is a C₁-C₂₀-alkylene radical, preferably C₁-C₈-alkylene radical, particularly preferably C₁-C₅-alkylene radical and
   R² is a straight-chain or branched C₁-C₂₀-alkyl radical, preferably C₁-C₈-alkyl radical, particularly preferably C₁-C₅-alkyl radical,
   where at least one radical X² is a group of the formula O—(R¹—O)ₘ—R²,
X³ is a —(CH₂)ₙ—R³ radical, in which
   n is a whole number from 0 to 16, preferably from 0 to 8, particularly preferably 0, 1, 2 or 3, where the methylene groups CH₂ of the alkylene chain (CH₂)ₙ can also have interruption via an if appropriate substituted aromatic radical, preferably phenyl, and
   R³ is hydrogen, a straight-chain or branched C₁-C₂₀-alkyl radical, preferably C₁-C₈-alkyl radical, particularly preferably C₁-C₅-alkyl radical, OH, halogen, preferably fluorine, chlorine, bromine or iodine, NR⁴₂, where R⁴ are identical or different and are hydrogen, straight-chain or branched C₁-C₂₀-alkyl radical, preferably C₁-C₈-alkyl radical, particularly preferably C₁-C₅-alkyl radical, C₃-C₈-cycloalkyl, preferably cyclohexyl, or a C₆-C₂₄-aryl radical, preferably C₆-C₁₄-aryl radical, —NHCH₂CH₂NH₂, —SH, —NCO, carbamate, acrylate, vinyl (—CH═CH₂), methacrylate, glycidoxy, COOR⁴, P(R⁴)₃, where R⁴ are identical or different and can have the abovementioned meanings,
   or R³ is a radical of the general formula (III), 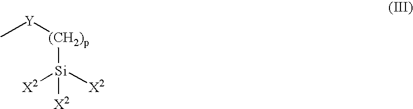
   in which
   X² has the range of meanings as in the general formula (II)
   p has the range of meanings of n in the general formula (II) and
   Y is NR⁵, where R⁵ is hydrogen or a straight-chain or branched C₁-C₂₀-alkyl radical, preferably C₁-C₈-alkyl radical, particularly preferably C₁-C₅-alkyl radical, or is C(R⁵)₂, where R⁵ is identical or different and can have the abovementioned meanings, or
X³ is an —NR⁵—(CH₂)ᵣ—NR⁵—R⁶ radical, where R⁵ can have meanings the same as those mentioned above for formula (III), r is a number from 1 to 10, preferably from 2 to 8, and R⁶ is the radical —Si(X²)₃, where X² are identical or different and can have the meanings mentioned above for formula (II).

It is preferable to use silanes of the general formula (II) in which
X² are identical or different and are a group of the formula O—(R¹—O)ₘ—R², in which
   m is a whole number from 0 to 20, preferably from 0 to 10,
   R¹ is a C₁-C₂₀-alkylene radical, preferably C₁-C₈-alkylene radical, particularly preferably C₁-C₅-alkylene radical and
   R² is a straight-chain or branched C₁-C₂₀-alkyl radical, preferably C₁-C₈-alkyl radical, particularly preferably C₁-C₅-alkyl radical, and
X³ is a —(CH₂)ₙ—R³ radical, in which
   n is a whole number from 0 to 16, preferably from 0 to 8, particularly preferably 0, 1, 2 or 3, where the methylene groups CH₂ of the alkylene chain (CH₂)ₙ can also have interruption via an if appropriate substituted aromatic radical, preferably phenyl, and
   R³ is hydrogen, a straight-chain or branched C₁-C₂₀-alkyl radical, preferably C₁-C₈-alkyl radical, particularly preferably C₁-C₅-alkyl radical, OH, halogen, preferably fluorine, chlorine, bromine or iodine, NR⁴₂, where R⁴ are identical or different and are hydrogen, straight-chain or branched C₁-C₂₀-alkyl radical, preferably C₁-C₈-alkyl radical, particularly preferably C₁-C₅-alkyl radical, C₃-C₈-cycloalkyl, preferably cyclohexyl, or a C₆-C₂₄-aryl radical, preferably C₆-C₁₄-aryl radical, —NHCH₂CH₂NH₂, —SH, —NCO, carbamate, acrylate, vinyl (—CH═CH₂), methacrylate, glycidoxy, COOR⁴, P(R⁴)₃, where R⁴ are identical or different and can have the abovementioned meanings.

It is further preferable to use silanes of the general formula (II) in which
X² are identical or different and
   are a straight-chain or branched C₁-C₂₀-alkyl radical, preferably C₁-C₈-alkyl radical, particularly preferably C₁-C₅-alkyl radical,
   a C₆-C₁₄-aryl radical, or
   a group of the formula O—(R¹—O)ₘ—R², in which
      m is a whole number from 0 to 20,
      R¹ is a C₁-C₂₀-alkylene radical, preferably C₁-C₈-alkylene radical, particularly preferably C₁-C₅-alkylene radical and
      R² is a straight-chain or branched C₁-C₂₀-alkyl radical, preferably C₁-C₈-alkyl radical, particularly preferably C₁-C₅-alkyl radical,
   where at least one radical X² is a group of the formula O—(R¹—O)ₘ—R², and
X³ is a —(CH₂)ₙ—R³ radical, in which
   n is a whole number from 0 to 16, preferably from 0 to 8, particularly preferably 0, 1, 2 or 3, where the methylene groups CH₂ of the alkylene chain (CH₂)ₙ can also have interruption via an if appropriate substituted aromatic radical, preferably phenyl, and
   R³ is a group of the general formula (III), 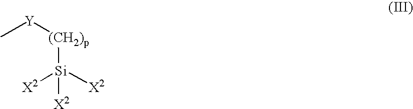
   in which
   X² has the range of meanings as in the general formula (II)
   p has the range of meanings of n in the general formula (II) and
   Y is NR⁵, where R⁵ is hydrogen or a straight-chain or branched C₁-C₂₀-alkyl radical, preferably C₁-C₈-alkyl radical, particularly preferably C₁-C₅-alkyl radical, or is C(R⁵)₂, where R⁵ is identical or different and can have the abovementioned meanings.

Specific silanes of the general formula (II) used with particular preference are: diethoxydimethylsilane, trimethoxymethylsilane, trimethoxy-n-propylsilane, n-hexadecyl-trimethoxysilane, triethoxy-n-propylsilane, triethoxy-n-octylsilane, triethoxy-n-hexadecyl-silane, trimethoxyvinylsilane, triethoxyvinylsilane, (3-methacryloxypropyl) trimethoxysilane ((CH₃O)₃Si((CH₂)₃—O—C(═O)—C(CH₃)═CH₂), tris(2-methoxyethoxy)vinylsilane, 3-amino-propyltriethoxysilane, ethylenebis(triethoxysilane), 1,8-bis(triethoxysilyl)octane, bis(trimethoxysilylpropyl)amine, bis(trimethoxysilylpropyl)ethylenediamine, diethoxymethylphenylsilane, bis(methyldiethoxysilylpropyl)amine, chloromethylmethyldiethoxysilane, N-cyclohexylaminomethylmethyldiethoxysilane and 3-(trimethoxysilyl)propylethylene-diamine.

Silanes of the general formula IV are moreover used, 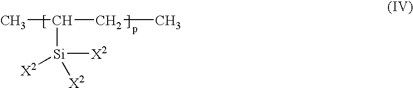
in which
X² are identical or different and their general, preferred and particularly preferred meanings can be the same as those in the general formula (II) and
n is a whole number from 2 to 5000, preferably from 2 to 500.

It is preferably that the radicals X² in the general formula (IV) are identical and are a group of the formula O—(R¹—O)ₘ—R², in which
m is a whole number from 0 to 20,
R¹ is a C₁-C₂₀-alkylene radical, preferably C₁-C₈-alkylene radical, particularly preferably C₁-C₅-alkylene radical and
R² is a straight-chain or branched C₁-C₂₀-alkyl radical, preferably C₁-C₈-alkyl radical, particularly preferably C₁-C₅-alkyl radical.
   Titanate:

Titanates used in the inventive vulcanizable compositions comprise those of the following formula (V)
(X⁴O)ₛ—Ti—(OX⁵)₄₋ₐ, (V)
where
s is 0, 1, 2, 3, or 4,
X⁴ are identical or different and are a straight-chain or branched C₁-C₂₀-alkyl radical, preferably C₁-C₈-alkyl radical, particularly preferably C₁-C₅-alkyl radical, in particular ethyl, propyl or butyl, and
X⁵ are identical or different and are an organofunctional group, preferably phosphate, benzenesulphonate, phenolate, amino, carboxy, ester, or salts thereof.

In the radical X⁴, individual methylene groups in the alkyl radical can also have been replaced by a —O— and/or —N(H)— grouping, and/or the terminal methyl group(s) in the alkyl radical can have been replaced by —NH₂.

Titanates preferably used are: tetra(ethyl) titanate, tetra(n-propyl) titanate, tetra(isopropyl) titanate, tetra(n-butyl) titanate, tetra(n-butylisopropyl) titanate, tetra(isobutyl) titanate, tetra(tert-butyl) titanate, tetra(isooctyl) titanate, and titanium(IV) 2-ethylhexoxide.

It is also possible to use isopropyl tris(N-aminoethylaminoethyl) titanate of the following structure 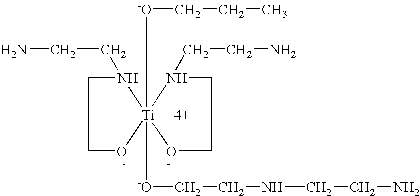
Data Concerning the Amounts of the Crosslinking Agent c) and of the Organotin Catalyst b):

The amount generally used of the crosslinking agent is from 0.1 to 25 parts by weight, preferably from 0.5 to 15 parts by weight and particularly preferably from 1 to 10 parts by weight, based on 100 parts by weight of the EVA.

The amount generally used of the organotin catalyst is from 0.01 to 5 parts by weight, preferably from 0.1 to 3 parts by weight and particularly preferably from 0.3 to 1.5 parts by weight, based on 100 parts by weight of the EVA.

Additives:

Conventional polymer additives can also be present alongside components a), b) and c) in the inventive vulcanizable composition. Among these polymer additives are, for example,
fillers,
antioxidants,
plasticizers,
processing aids, such as mould-release agents.

Examples of fillers used are carbon black, silica, barium sulphate, titanium dioxide, zinc oxide, calcium oxide, calcium carbonate, magnesium oxide, aluminium oxide, aluminium hydroxide, iron oxide, diatomaceous earth or silicates.

The amount usually used of the fillers is from 5 to 300 parts by weight per 100 parts by weight of EVA.

The antioxidants used can comprise any of the antioxidants know to the person skilled in the art, and also in particular and advantageously those which cannot otherwise be used during peroxide crosslinking of EVA. Examples of those that can be used are oligomerized 2,2,4-trimethyl-1,2-dihydroquinoline (TMQ), styrenated diphenylamine (DDA), octylated diphenylamine (OCD) or the zinc salt of 4- and 5-methylmercaptobenzimidazole (ZMB2). Alongside these, it is also possible to use the known phenolic antioxidants, such as sterically hindered phenols, or antioxidants based on phenylenediamine. It is also possible to use a combination of the specified antioxidants.

The amount usually used of antioxidants is from 0.1 to 20 parts by weight, preferably from 0.1 to 5 parts by weight, particularly preferably from 0.3 to 3 parts by weight, per 100 parts by weight of EVA.

Useful plasticizers include for example dioctyl phthalate, dibenzyl phthalate, butyl benzyl phthalate, hydrocarbon oils, N-(n-butyl)benzenesulphonamide.

The amount usually used of a plasticizer is from 0.1 to 50 parts by weight per 100 parts by weight of EVA.

Examples of mould-release agents that can be used are: saturated or partially unsaturated fatty and oleic acids or their derivatives (in the form of fatty acid esters, fatty acid salts, fatty alcohols or fatty acid amides), and moreover products that can be applied to the mould surface, for example products based on low-molecular-weight silicone compounds, products based on fluoropolymers, and also products based on phenolic resins.

The amounts used of the mould-release agents as constituent of a mixture are from 0.2 to 10 parts by weight, preferably from 0.5 to 5 parts by weight, based on 100 parts by weight of EVA.

The invention moreover provides the preparation of the vulcanizable composition, by mixing at least one copolymer based on the monomers ethylene and vinyl acetate with vinyl acetate content of at least 45% by weight, based on the copolymer, at least one organotin catalyst and at least one crosslinking agent selected from the group consisting of silanes and titanates, and selecting the mixing temperature in such a way that no crosslinking of the ethylene-vinyl acetate copolymers occurs during this mixing procedure. Either all of the components are simultaneously mixed with one another or all of the components other than the crosslinking agent are first mixed and addition of the crosslinking agent is delayed, taking place subsequently.

The mixing takes place in the mixing apparatuses and mixing assemblies known to the person skilled in the art, examples being internal mixers (tangential or intermeshing rotors), rolls, kneaders or mixing extruders.

Description of Crosslinking Process:

During the crosslinking process, two or more ethylene-vinyl acetate polymer chains are bonded to one another chemically by way of at least two transesterification reactions, by way of the crosslinking agent in the form of the silane or titanate—with catalysis by the organotin compound. The term crosslinking site is also used for this type of linkage

If, by way of example, silanes of the general formula (II) are used, the silane is first applied by grafting to the ethylene-vinyl acetate copolymers in a first transesterification reaction by way of the group of the formula —O—(R¹—O)ₘ—R², and then bonding occurs to further ethylene-vinyl acetate copolymer chains, for example by way of a further functional group in the radical X² or X³, in a second transesterification reaction, thus achieving crosslinking.

The crosslinking of the ethylene-vinyl acetate copolymers or the location of the silane or titanate by grafting to the ethylene-vinyl acetate copolymers is usually carried out in the temperature range from 130° C. to 250° C. The person skilled in the art can easily determine the suitable crosslinking temperature on the basis of the respective silane used.

The invention moreover provides the use of the inventive vulcanizable compositions for production of products with elastomeric properties. Examples of these products are moulded products, cables, hoses, extrusion products or calendaring products.

A typical shaping process is used to produce such products with elastomeric properties.

By way of example, they are produced by taking the inventive compositions prepared as described above by mixing and subjecting them to compression moulding, compression transfer moulding, an injection moulding process or an extrusion process or calendaring.

It is moreover also possible to mix the components of the inventive composition in one of the abovementioned mixing assemblies at a temperature which itself leads to a first transesterification reaction, and then to introduce them to the shaping process.

The crosslinking of the specific ethylene-vinyl acetate copolymers with high vinyl acetate content is achieved via transesterification using silanes or titanates as crosslinking agents, rather than with peroxides, as known hitherto to persons skilled in the art. This permits for the first time the use, for ethylene-vinyl acetate copolymers with this relatively high vinyl acetate content, of antioxidants which are considered to be free-radical scavengers. Examples of these are paraphenylenediamines (also termed PPDs), and also sterically hindered phenols. Furthermore, it is possible for the first time to use, in the inventive vulcanizable composition, plasticizers which usually interfere with the peroxide crosslinking carried out hitherto, examples being high-aromatic-content plasticizers or polyether ester plasticizers. For the first time it is therefore possible to achieve controlled adjustment of the low-temperature flexibility of ethylene-vinyl acetate copolymers with relatively high vinyl acetate contents.

### EXAMPLES

### Examples 1-26

The parent formulation of the vulcanizable compositions according to Examples 1-26 comprised:

| | |
|---|---|
| Levapren ® 600HV(R) | 100 phr |
| Crosslinking agent/functionalizing agent | 10 phr |
| Organotin catalyst | 1 phr |

(phr = parts per hundred parts of rubber, i.e. Levapren ® 600 HV(R))

Dibutyltin oxide (DBTO) was used as organotin catalyst for all of the examples.

The crosslinking agent/functionalizing agent used comprised the silanes whose chemical name, and also trade name, is listed in Table 1. These are commercially available.

The three components were mixed on a laboratory roll system and carefully homogenized in order to obtain the inventive vulcanizable composition in the form of a milled sheet.

The vulcanization behaviour of a specimen of each of these milled sheets was characterized in an MDR 2000 Moving Die Rheometer from the company Alpha Technologies.

The test time here was 20 min, the frequency was 1.66 Hz, and the angle of oscillation was 0.5°. The test temperature selected was 210° C. The variable (S′ₘₐₓ-S′ₘᵢₙ) (maximum value of viscose torque—minimum value of viscose torque) serves as measure for the crosslinking site density. This can lead to a conclusion about the crosslinking efficiency of the silanes or, respectively, the grafting of the silanes onto the ethylene-vinyl acetate copolymers.

From the various values collated in Table I for the variable (S′ₘₐₓ-S′ₘᵢₙ), it can be seen that high crosslinking efficiency is achieved under the stated conditions using a number of silanes whereas in the case of other silanes grafting onto the polymer chains proceeds, but no pronounced crosslinking occurs at this stage.

Description of MDR 2000 Moving Die Rheometer:

The MDR 2000 serves for determination of vulcanization behaviour, in particular of vulcanization rate of rubber mixtures. The test chamber is a closed system. The two halves of the test chamber are biconical, i.e. the test chamber is formed by two opposite flat cone frusta. As a consequence of this shape, there is an identical shear angle, independent of the radius, in the specimen.

Corresponding to the rotationally symmetric shape of the reaction chamber, the lower half of the chamber executes an oscillating rotary movement with variable angular amplitude, the result being uniform stressed distribution in the specimen. Drive is provided by a servo drive attached directly to the drive shaft of the lower test chamber. Controlled electronics regulate this drive. The amplitude of the angle of oscillation can be adjusted in steps of 0.2°, 0.5°, 1.0° and 3.0°. The frequency is 1.66 Hz.

On closing the test chamber, the upper half of the test chamber is superposed on the lower half of the test chamber. This completely closes the reaction chamber, and the specimen is always under pressure during the test and, respectively, vulcanization process.

The temperature control (40-225° C.) of the two electrically heated halves of the test chamber takes place by way of the software with in each case a separate control loop. PT 100 resistance thermometers are used for temperature regulation and temperature measurement.

The test time can be prescribed.

Torque measurement takes place by way of a DMS torque recorder, which has been connected to the upper half of the test chamber.

By way of the time-dependent torque measured and the phase shift with respect to the mechanical loading through the oscillating lower chamber, it is possible to determine the viscose and elastic torque (S′ and S″) exerted through the mixture. The measured values determined, such as toque, viscose and elastic component, and the temperature of the upper and lower test chamber, are stored and plotted on the screen as a function of test time.

TABLE 1
Silanes used

| | | Abbreviation/ | |
|---|---|---|---|
| Example | Silane/chemical name | trade name | S′max-S′min |
| 1 | Tetramethylorthosilane | TMOS | 11.2 |
| 2 | Tetraethylorthosilane | TEOS | 18.0 |
| 3 | Tetrapropylorthosilane | TPOS | 17.8 |
| 4 | Tetrabutylorthosilane | TBOS | 12.3 |
| 5 | Trimethoxymethylsilane | TMMS | 1.3 |
| 6 | Trimethoxypropylsilane | TMPS | 3.3 |
| 7 | Vinyltrimethoxysilane | VTMO | 0.2 |
| 8 | Poly(vinyltrimethoxysilane) | VTMO hydrolyzed | 5.2 |
| 9 | Hexadecyltrimethoxysilane | VP Si 116 | 1.2 |
| 10 | (3-Methacryloxypropyl)trimethoxysilane | MEMO | 4.2 |
| 11 | Tris(2-methoxyethoxy)vinylsilane | VTMOEO | 1.9 |
| 12 | Triethoxypropylsilane | Si ® 203 | 15.4 |
| 13 | Triethoxyoctylsilane | VP Si 208 | 10.8 |
| 14 | Triethoxyhexadecylsilane | VP Si 216 | 6.7 |
| 15 | Triethoxyvinylsilane | VP Si 225 | 11.9 |
| 16 | 3-Aminopropyltriethoxysilane | AMEO | 10.8 |
| 17 | Ethylenebis(triethoxysilane) | Silquest ® Y 9805 | 10.7 |
| 18 | 1,8-Bis(triethoxysilyl)octane | SIB 1824 | 13.9 |
| 19 | Bis(trimethoxysilylpropyl)amine | Silquest ® 1170 | 7.1 |
| 20 | Bis(trimethoxysilylpropyl)ethylenediamine | XS 951 | 5.8 |
| 21 | Diethoxymethylphenylsilane | SiSiB PC8612 | 1.6 |
| 22 | Polydiethoxysiloxane | PSI-021 | 5.7 |
| 23 | Bis(methyldiethoxysilylpropyl)amine | SIB 1620 | 5.8 |
| 24 | Chloromethylmethyldiethoxysilane | SIC2292.0 | 0.7 |
| 25 | N-Cyclohexylaminomethylmethyldiethoxysilane | Geniosil ® XL 924 | 8.2 |
| 26 | 3-(Trimethoxysilyl)propylethylenediamine | Silquest ® A1120 | 2.1 |

### Example 27

The formulation of the vulcanizable compositions according to Example 27 comprised:

| | |
|---|---|
| Levapren ® 600HV (R) | 100 phr |
| Hexadecyltrimethoxysilane | 10 phr |
| DBTO | 1 phr |

(phr = parts per hundred parts of rubber, i.e. Levapren ® 600 HV(R))

A mixture was prepared on a laboratory roll system from the three abovementioned components and was heated at 21° C. for 30 minutes.

A test on the mixture after the heating procedure in the Moving Die Rheometer gave a value of 1.2 for (S′max-S′min). This means that no substantial crosslinking has yet occurred, but the DSC measurements described below show that silane had been bonded to the copolymer chains of the Levapren by way of a first transesterification reaction.

For this, DSC measurements were carried out on the mixture heated to 210° C. for 30 min. A glass transition temperature (Tg) reduced by about 4-5 degrees from that of the original mixture prior to the heating procedure was found. This can be attributed to the “plasticizer effect” of the silane. A melting peak at about 40° C. was also measured and is attributable to crystalline ethylene structures of the hexadecyl chain of the silane used.

The mixture was then extracted with methanol, thus removing all of the free substances not bonded to the ethylene-vinyl acetate copolymer. The mixture remaining after extraction was again DSC-tested. It was found that the glass transition temperature Tg had altered again approximately to the value for pure Levapren® 600H V. However, a melting peak at about 40° C. remained, and is attributable to crystalline ethylene structures in the hexadecyl chain of the silane used. This means that a portion of the silane has been bonded covalently to the copolymer through the transesterification reaction.

### Example 28

The formulation of the vulcanizable compositions according to Example 28 comprised:

| | |
|---|---|
| Levapren ® 600HV (R) | 100 phr |
| KR 44 * | 10 phr |
| DBTO | 1 phr |

(phr = parts per hundred parts of rubber, i.e. Levapren ® 600 HV(R))
* KR 44 is isopropyl tris(N-aminoethylaminoethyl) titanate of the following structure:

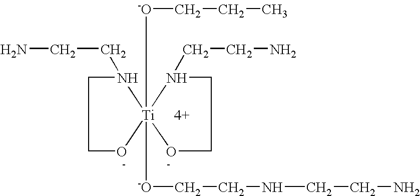

A mixture was prepared on a laboratory roll system from the three abovementioned components and was heated at 210° C. for 30 minutes. The heated mixture was then extracted with methanol in order to remove all of the substances not bonded to the copolymer, and was subjected to quantitative elemental analysis by means of ICP-AES (inductively coupled plasma atomic emission spectroscopy), in order to prove that transesterification had grafted the titanate onto the Levapren copolymer. 1.3% by weight of titanium, based on the entire vulcanizable composition used, have been bonded via transesterification to the Levapren copolymer.

What is claimed is:

1. A vulcanizable composition comprising
a) at least one copolymer based on the monomers ethylene and vinyl acetate with vinyl acetate content of at least 45% by weight, based on the copolymer,
b) at least one organotin catalyst and
c) at least one crosslinking agent selected from the group consisting of silanes and titanates.

2. The vulcanizable composition according to claim 1 comprising at least one copolymer based on the monomers ethylene and vinyl acetate with vinyl acetate content in the range from 45 to 93% by weight, based on the copolymer.

3. The vulcanizable composition according to claim 2 comprising at least one copolymer based on the monomers ethylene and vinyl acetate with vinyl acetate content in the range from 50 to 80% by weight, based on the copolymer.

4. The vulcanizable composition according to any one of claims 1 to 3 comprising at least one organotin catalyst from the group consisting of monoalkyltin compounds, dialkyltin compounds, trialkyltin compounds, triaryltin compounds, tetraalkyltin compounds and stannous salts of carboxylic acids, to the extent that these stannous salts are not one of the abovementioned compounds.

5. The vulcanizable composition according to any one of claims 1 to 4, using at least one silane of the general formula (I), 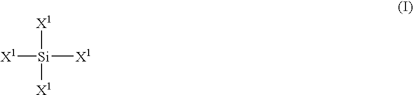
in which
X¹ are identical or different and are a group of the formula O—(R¹—O)ₘ—R², in which m is a whole number from 0 to 20, R¹ is a C₁-C₂₀-alkylene radical, and R² is a straight-chain or branched C₁-C₂₀-alkyl radical.

6. The vulcanizable composition according to any one of claims 1 to 4, using at least one silane selected from the group of tetramethoxysilane, tetraethoxysilane, tetra-n-propoxysilane, tetra-n-butoxysilane and tetrakis(2-butoxyethoxy)silane.

7. The vulcanizable composition according to any one of claims 1 to 4, using at least one silane of the general formula (II) 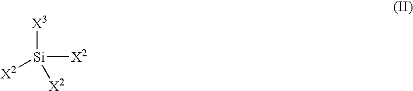
in which
X² are identical or different and are
a straight-chain or branched C₁-C₂₀-alkyl radical,
a C₆-C₁₄-aryl radical, or
a group of the formula O—(R¹—O)ₘ—R², in which
m is a whole number from 0 to 20,
R¹ is a C₁-C₂₀-alkylene radical, and
R² is a straight-chain or branched C₁-C₂₀-alkyl radical,
wherein at least one radical X² is a group of the abovementioned formula O—(R¹—O)ₘ—R²,
X³ is a —(CH₂)ₙ—R³ radical, in which
n is a whole number from 0 to 16, wherein the methylene groups CH₂ of the alkylene chain (CH₂)ₙ can also have interruption via an if appropriate substituted aromatic radical and
R³ is hydrogen, a straight-chain or branched C₁-C₂₀-alkyl radical, OH, halogen, NR⁴₂, where R⁴ are identical or different and are hydrogen, straight-chain or branched C₁-C₂₀-alkyl, C₃-C₈-cycloalkyl, or a C₆-C₂₄-aryl radical, —NHCH₂CH₂NH₂, —SH, —NCO, carbamate, acrylate, vinyl (—CH═CH₂), methacrylate, glycidoxy, COOR⁴, or P(R⁴)₃, where R⁴ are identical or different and can have the abovementioned meanings,
or R³ is a radical of the general formula (III), 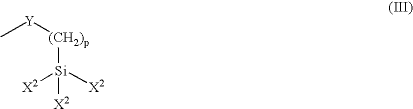
in which
X² has the range of meanings as in the general formula (II)
p has the range of meanings of n in the general formula (II) and
Y is NR⁵, where R⁵ is hydrogen or a straight-chain or branched C₁-C₂₀-alkyl radical, or is C(R⁵)₂, where R⁵ is identical or different and can have the abovementioned meanings, or
X³ is an —NR⁵—(CH₂)ᵣ—NR⁵—R⁶ radical, where R⁵ can have meanings the same as those mentioned above for general formula (III), r is a number from 1 to 10, and R⁶ is the radical —Si(X²)₃, where X² are identical or different and can have the meanings mentioned above for general formula (II).

8. The vulcanizable composition according to claim 7, using at least one silane of the general formula (II), where
X² are identical or different and are a group of the formula O—(R¹—O)ₘ—R², in which
m is a whole number from 0 to 20,
R¹ is a C₁-C₂₀-alkylene radical,
R² is a straight-chain or branched C₁-C₂₀-alkyl radical, and
X³ is a —(CH₂)ₙ—R³ radical, in which
n is a whole number from 0 to 16, wherein the methylene groups CH₂ of the alkylene chain (CH₂)ₙ can also have interruption via an if appropriate substituted aromatic radical, and
R³ is hydrogen, a straight-chain or branched C₁-C₂₀-alkyl radical, OH, halogen, NR⁴₂, where R⁴ are identical or different and are hydrogen, straight-chain or branched C₁-C₂₀-alkyl, C₃-C₈-cycloalkyl, or a C₆-C₂₄-aryl radical, —NHCH₂CH₂NH₂, —SH, —NCO, carbamate, acrylate, vinyl (—CH═CH₂), methacrylate, glycidoxy, COOR⁴, P(R⁴)₃, where R⁴ are identical or different and can have the abovementioned meanings.

9. The vulcanizable composition according to claim 7, using at least one silane of the general formula (II), where
X² are identical or different and are
a straight-chain or branched C₁-C₂₀-alkyl radical,
a C₆-C₁₄-aryl radical, or
a group of the formula O—(R¹—O)ₘ—R², in which
m is a whole number from 0 to 20,
R¹ is a C₁-C₂₀-alkylene radical, and
R² is a straight-chain or branched C₁-C₂₀-alkyl radical,
wherein at least one radical X² is a group of the formula O—(R¹—O)ₘ—R², and
X³ is a —(CH₂)ₙ—R³ radical, in which
n is a whole number from 0 to 16, wherein the methylene groups CH₂ of the alkylene chain (CH₂)ₙ can also have interruption via an if appropriate substituted aromatic radical, and
R³ is a group of the general formula (III), (CH₂)ₚ (III), 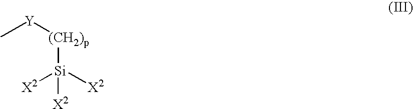
in which
X² has the range of meanings as in the general formula (II) general formula (II)
p has the range of meanings of n in the general formula (II) and
Y is NR⁵, where R⁵ is hydrogen or a straight-chain or branched C₁-C₂₀-alkyl radical, or is C(R⁵)₂, where R⁵ is identical or different and can have the abovementioned meanings.

10. The vulcanizable composition according to claim 7, using at least one silane of the general formula (II) selected from the group consisting of diethoxydimethylsilane, trimethoxymethylsilane, trimethoxy-n-propylsilane, n-hexadecyltrimethoxysilane, triethoxy-n-propylsilane, triethoxy-n-octylsilane, triethoxy-n-hexadecylsilane, trimethoxyvinylsilane, triethoxyvinylsilane, (3-methacryloxypropyl)trimethoxysilane ((CH₃₀)₃Si(CH₂)₃—O—C(═O)—C(CH₃)═CH₂), tris(2-methoxyethoxy)vinylsilane, 3-amino-propyltriethoxysilane, ethylenebis(triethoxysilane), 1,8-bis(triethoxysilyl)octane, bis(trimethoxysilylpropyl)amine, bis(trimethoxysilylpropyl)ethylenediamine, diethoxy-methylphenylsilane, bis(methyldiethoxysilylpropyl)amine, chloromethylmethyldiethoxy-silane, N-cyclohexylaminomethylmethyldiethoxysilane and 3-(trimethoxysilyl)propyl-ethylenediamine.

11. The vulcanizable composition according to any one of claims 1 to 10, using at least one titanate of the general formula (V),
(X⁴O)ₛ—Ti—(OX⁵)₄₋ₛ, (V)
where
is 0, 1, 2, 3, or 4,
X⁴ are identical or different and are a straight-chain or branched C₁-C₂₀-alkyl radical and
X⁵ are identical or different and are an organofunctional group.

12. The vulcanizable composition according to any one of claims 1 to 10, using at least one titanate selected from the group consisting of tetra(ethyl)titanate, tetra(n-propyl)titanate, tetra(isopropyl)titanate, tetra(n-butyl)titanate, tetra(n-butylisopropyl)titanate, tetra(isobutyl)titanate, tetra(tert-butyl)titanate, tetra(isooctyl)titanate, titanium(IV) 2-ethylhexoxide and isopropyl tris(N-aminoethylaminoethyl)titanate.

13. The vulcanizable composition according to any one of claims 1 to 12, wherein the amount used of the crosslinking agent is from 0.1 to 25 parts by weight, based on 100 parts by weight of the copolymer based on the monomers ethylene and vinyl acetate.

14. The vulcanizable composition according to any one of claims 1 to 13, using an amount of from 0.01 to 5 parts by weight of the organotin catalyst, based on 100 parts by weight of the copolymer based on the monomers ethylene and vinyl acetate.

15. A process for preparation of the vulcanizable composition according to any one of claims 1 to 14, comprising mixing at least one copolymer based on the monomers ethylene and vinyl acetate with vinyl acetate content of at least 45% by weight, based on the copolymer, at least one organotin catalyst and at least one crosslinking agent selected from the group consisting of silanes and titanates, and selecting the mixing temperature in such a way that no crosslinking of the ethylene-vinyl acetate copolymers occurs during this mixing procedure.

16. A method of producing elastomeric products comprising subjecting the vulcanizable compositions according to any one of claims 1 to 14 to compression moulding, compression transfer moulding, an injection moulding process or an extrusion process or calendaring.

17. The method according to claim 16 for producing moulded products, cables, hoses, extrusion products or calendaring products.
